(19) United States
(12) Patent Application Publication
(10) Pub. No.: US 2022/0159925 A1
(43) Pub. Date: May 26, 2022

(54) APPARATUS AND METHOD FOR PRELOADING A PLURALITY OF FEED TYPES OF A FEED MIX FOR LIVESTOCK AND METHOD FOR PREPARING FEED MIXES

(71) Applicant: Trioliet B.V., Oldenzaal (NL)

(72) Inventor: Robert Jan LIET, Oldenzaal (NL)

(21) Appl. No.: 17/100,994

(22) Filed: Nov. 23, 2020

(51) Int. Cl. A01K 5/00; B01F 13/00; B01F 15/00; B01F 15/02

(52) U.S. Cl. CPC A01K 5/007; B01F 13/0013; B01F 15/00194; B01F 2015/0204; B01F 2215/0008; B01F 2215/0024; B01F 15/0201

(57) ABSTRACT

Preloading a plurality of feed types of a feed mix for livestock in a mixing plant. Feed types are conveyed towards a mixer. Bunkers selectively discharge one of the feed types on a loading conveyor. A controller controls a preloading weight of the feed types to be discharged onto the loading conveyor. Feed types are individually discharge onto dump spots of the loading conveyor at the bunkers and terminate when a predetermined total weight is reached or interrupt when a maximum preloading capacity is reached or feed reaches the end of the loading conveyor. Feed types may be individually discharged from the bunkers onto the dump spots and the main component loaded into the mixer by a loading vehicle, such that the weight of the main portion and the weight of the supplemental portion add up to a programmed total weight of the main component.

### FIELD OF THE INVENTION

The invention relates to an apparatus and a method for preloading a plurality of feed types of a feed mix for livestock and a method for preparing feed mixes.

### BACKGROUND OF THE INVENTION

Big farms with many thousands of cows tend to use electrically driven stationary mixers that offer saving on energy cost and maintenance cost over mobile mixers powered by Diesel engines. The feed mixes are brought from the stationary mixer to the cow groups by so called feed out trucks that are fast and relatively cheap in investment and use. The components of the feed mixes are centrally stored in the so called feed kitchen with so called commodity barns, in which so called bays are present.

Usually, three to four main components such as corn silage, grass silage in two qualities, and roughage are required in big quantities and can be dumped in heaps near the mixers. Moreover, e.g. ten types of byproducts such as straw, alfalfa hay, brewers grain, cotton seed, sugar beet pulpe, soja bean hulls and the like are stored in the commodity barn bays, and e.g. ten types of concentrates, grains or flours are stored in the commodity barn bays or upright silos.

Since it is not uncommon to handle 600 tons of feed daily (e. g. for 12 000 cows) in about 30 feed mixes of 20 tons each, loading vehicles with big buckets are used to load most of the components of the feed mix (e. g. two main components, four byproducts and four minerals) into the mixers. The loading vehicles run back and forth to the commodity barn bays and to the heaps of silage hauled from other locations, scoping the feed up again then trying to dump exactly the right quantity into the mixers and then run back with the surplus of the feed to the commodity bays again. In an effort to dump in the required amounts of the feed types, the filled bucket may be shaken by the driver to make a small quantity fall out, which can be hard to control and also creates a lot of wear on the bushings in the hinges and pivots. Moreover, it is not possible to efficiently and accurately load the smaller amounts of the byproducts and minerals with a big bucket. Although weighing systems on buckets are known, this approach is neither very accurate nor widely spread.

These disadvantages can be partly overcome by discharging the byproducts from stationary bunkers onto a loading conveyor and convey the byproducts by means of the loading conveyor and a cross conveyor to one of the mixers. The silos can be connected to a mineral collection bin arranged over the cross conveyor.

Thus the loading can consists of at least three more or less simultaneous processes, namely driver-controlled loading with a loading vehicle, precollection in the mineral bin and (at least partly) preloading on the loading conveyor. The sequence in which the three processes deliver the feed types into the mixer may vary.

Usually the long material and big quantities go in first, so the mixers can process it. During the manual loading of main components such as grass and corn, the other two processes start, namely preloading onto the loading conveyor and collection of minerals/concentrates. When the last main component, e. g. the corn, is finished, then the loading conveyor usually starts to dump the preloaded quantity followed by the loading of the bunkers one by one, and then finally the emptying of the quantity collected in the concentrates collection bin. After finishing of the mixing cycle, the mix is discharged into the feed out truck and delivered to the intended cow group.

Since the loading conveyor, the mineral collection bin, the cross conveyor and the mixer may have weighing systems, the quantity already preloaded on the loading conveyor, the quantity on the way to the mixer, and the quantity already in the mixer can be computed. When the desired quantity of a particular feed type is reached, the discharge from the bunker is stopped, and the loading conveyor and cross conveyor run empty until the mixer has received all of the preloaded feed type.

However, each time one switches from bunker to bunker, the loading conveyor and the cross conveyor need to completely empty itself in order to avoid spoiling the discharge of the next ingredient with the rest feed on the loading conveyor or cross conveyor. Due to the length of the loading conveyor, this procedure is quite time-consuming.

As an alternative approach, US 2017/0188620 discloses a mixing plant which can preload the total quantity of the feed mix onto a loading conveyor. However, this requires a very big loading conveyor as some feed types such as hay and straw are extremely bulky. Due to the required daily feed quantities, enormous bunkers would be necessary as well. This would mean that the total quantities need to run over the loading conveyor and cross conveyor, thus creating a lot of wear and tear. If there are a lot of different feed types, the loading conveyor can become very costly. Moreover, this approach has not been able to reduce the time required for the overall mixing process.

Thus there is demand for improved apparatuses and method overcoming at least one of the above drawbacks when preparing a feed mix for livestock in a mixing plant.

### SUMMARY OF THE INVENTION

This goal is achieved with an apparatus according to the different embodiments and a method according to the different processes.

According to a first aspect of the invention, the apparatus is suitable for preloading feed types of a feed mix for livestock, the apparatus comprising: a loading conveyor for conveying the feed types towards a mixer for preparing the feed mix; a plurality of bunkers each configured for selectively discharging one of the feed types on the loading conveyor; and a control system programmed:
to hold a preloading plan of a preloading cycle, the preloading plan defining at least preloading weights of the feed types to be discharged onto the loading conveyor;
to sequentially move dump spots of the loading conveyor to dump areas of the bunkers and to individually discharge the feed types onto the dump spots, depending on the preloading plan, and in particular depending on space/weight capacities of the dump spots for the individual feed types; and
to terminate the preloading cycle when a predetermined total weight of the required feed types is reached, or to interrupt the preloading cycle when a maximum total capacity of the loading conveyor is reached or feed reaches a downstream end of the loading conveyor, and convey the preloaded feed types together towards the mixer.

The loading conveyor comprises a basically horizontal first section and a subsequent (in conveying direction) second section sloping upwards. The first section covers the the discharge sections of the bunkers and some additional room for manually loading on the chain in case of emergency.

The invention is based on the idea of preloading different types of feed on the first section of the loading conveyor and precollecting the different types of feed on the first and second sections of the loading conveyor, preferably the total feed quantity of all byproducts and supplemental portions of main components, or at least as many feed types as possible in accordance with the total capacity (regarding weight and/or space) of the loading conveyor.

This can be done by intermittently moving the loading conveyor over defined distances, so a particular bunker can dump a target weight/quantity on at least one dump spot of the loading conveyor until the total preloading weight/quantity of a particular feed type is done. The weight capacity of the dump spots is what can be stored on the loading conveyor within a single discharge of a particular feed type/component from a bunker. The length of the dumping spot usually corresponds to the full width of the bunker (in conveying direction).

The weight capacity/maximum quantity per discharge may differ from feed type to feed type, depending on the specific weight of the particular feed type and/or other properties of the feed types. The target weight/quantity of a particular discharge can be a portion of the weight capacity if the preloading weight/total preloading quantity of the feed type is done with the discharge of this target weight/quantity, or if the dump spot for the particular discharge is already partly filled with another feed type.

When the preloading weight/total preloading quantity of a particular feed type has been discharged in accordance with the preloading plan, the bunker of the next feed type in the preloading plan is activated, the loading conveyor is intermittently driven to position another dump spot at this bunker, and the contained feed type is discharged in the same way as explained above.

This sequential scheme of discharge of the various feed types (byproducts and/or supplementary portions of main components) onto the loading conveyor is continued according to the preloading plan until all required feed types are preloaded on the chain, or until the maximum total load capacity of the loading conveyor is reached, or until feed is arriving at the end of the chain where a loading sensor prevents premature dropping off.

All preloaded/pre-collected feed types (byproducts and/or supplementary portions of main components) are then conveyed on the loading conveyor towards the chosen mixer thereby emptying the loading conveyor. In case the discharge had to be interrupted because of capacity limits (maximum weight and/or space on the loading conveyor), the discharge scheme is resumed according to the preloading plan in order to discharge the remaining byproducts and/or supplementary portions of the main components on the previously emptied loading conveyor.

The benefit is that the loading conveyor needs to be emptied only if the total quantity of the necessary feed types has been loaded or the maximum weight capacity or space capacity of the loading conveyor is reached. Thus time loss due to repeated emptying of the loading conveyor can be minimized or even avoided.

The loading conveyor may have a frequency drive capable to drive the chain a number of pulses at a slow speed forward and to drive the loading conveyor fast in case of transport to one of the mixers. A pulse counter can be provided on the tensioner shaft of the chain.

At the downstream end of the loading conveyor, there may be a loading sensor detecting if there is laying feed on the chain.

The loading conveyor is mounted on weighing bars (weighing system). Thus, it is possible to know what weight is on the chain and to weigh off a certain quantity of a feed type on the chain, by activating the bunkers and discharging a particular feed type therefrom.

The bunkers may be driven by a hydrostatic pump, after activating the bunkers one by one, by means of associated hydraulic valves. However, other drives for the bunkers are possible as well, such as electric motors.

The control system may comprise a (software-implemented) so called afterfall function taking into account how much weight of a particular feed type will averagely continue to fall onto the chain when the drive of a particular bunker is stopped. According to the afterfall function, the target weight of a particular feed type is corrected by subtracting the afterfall weight of this feed type, and the drive is stopped at that corrected target weight (the calculated difference). In an effort to increase the accuracy of the individual discharges, the afterfall weight can be automatically calculated and/or adjusted in the control unit depending on the feed type to be discharged next.

Alternatively or additionally it is possible to equip the bunkers with individual weighing systems. In this case, several bunkers can be activated at the same time for simultaneous/overlapping discharge of different feed types on the loading conveyor, in an effort to save time. A simultaneous discharge can be achieved with a common and suitably powerful pump and flow sharing valves, or with multiple pumps.

Alternatively or additionally the pump motor can comprise a frequency drive. The control system may then drop the motor frequency after a desired portion, e. g. 95%, of the target weight has been discharged. For instance, the frequency drive may drop the frequency to e.g. 20%, thereby causing the pump motor and pump combination to reduce speed during the discharge of the remaining portion, e. g. 5%, of the target weight. This increases the systematic accuracy of the discharge process and decreases the spread in afterfall.

The mixers can be vertical mixers, horizontal mixers, mixers of the reel type or any other type.

According to a second aspect of the invention, the control system may be programmed to automatically resume the preloading cycle after the loading conveyor has been emptied.

According to a third aspect, the length of the dump spots may basically correspond to the width of the dump areas, when seen in a conveying direction of the loading conveyor, and the control system is programmed to intermittently drive the loading conveyor over distances basically corresponding to the length of the dump spots.

According to a fourth aspect, the control system may be programmed to determine remaining loading capacities of dump spots that have not been fully loaded with a particular feed type.

According to a fifth aspect of the invention, an apparatus for loading a plurality of feed types of a feed mix for livestock in a mixing plant comprises: one or more bunkers configured for selectively loading one or more of the feed types directly or indirectly in a mixer for preparing the feed mix; and a control system programmed to load at least one of the feed types directly or indirectly in the mixer as a supplemental portion of a main component of the feed mix, in particular of a roughage type, loaded into the mixer with a loading vehicle, such that the weight of the main portion and the weight of the supplemental portion add up to a programmed total weight of the main component.

The apparatus may comprise a loading conveyor for conveying the feed types towards a mixer for preparing the feed mix; a plurality of bunkers each configured for selectively discharging one of the feed types on the loading conveyor; and a control system programmed:
to hold a preloading plan of a preloading cycle, defining at least preloading weights of the feed types to be discharged onto the loading conveyor, wherein at least one of the feed types to be discharged on the loading conveyor is a supplemental portion of a main component of the feed mix, such as a roughage type; and
to sequentially move dump spots of the loading conveyor to the bunkers and to individually discharge the feed types onto the dump spots, depending on the preloading plan,
   wherein the control system is programmed to control the discharge of the supplemental portion of the main component in accordance with a main portion of the main component loaded into the mixer, in particular by means of a loading vehicle, such that the weight of the main portion and the weight of the supplemental portion add up to a programmed total weight of the main component.

The apparatus may comprise, for example, at least two, in particular at least four, bunkers for the different byproducts and at least one, in particular at least two bunkers for the main components. The main components are preferably of the roughage type and may be corn, grass silage of a first quality, grass silage of a second quality and GPS.

The control system comprises a user interface/an in-cab control unit to be installed in a loading vehicle. The user interface may comprise a touchscreen with a confirmation button confirming that a predetermined weight of the main component (prefill weight) of the feed mix has been done.

Alternatively a minimum threshold value of the prefill weight can be saved in the control system for at least one main component of the feed mix. Once weight of the main portion (actual prefill weight) measured in the mixer reaches the associated minimum threshold value, the driver of the loading vehicle is informed to stop the manual (loading vehicle) loading of this main component, and the control system calculates the weight of a supplemental portion by subtracting the actual prefill weight from the total target weight of this main component in the feed mix.

The calculated supplemental portion (weight) is then input into the preloading plan as the preloading weight of the supplemental portion of this main component to be discharged from the respective bunker onto the loading conveyor.

Alternatively, the weight of the main portion (actual prefill weight) in the mixer may be measured without defining a minimum threshold. A particular manual prefill procedure could be terminated anytime by the driver of the loading vehicle, and after confirmation of the prefill end, the weight of the supplemental portion could be calculated based thereon.

This procedure is preferably repeated for all main components of the feed mix.

In this way the driver is released from exact loading; he can just dump in full buckets and move to the next job. This may save one loading vehicle to operate the installation, the driver does not need to drive back to dump the surplus and there is the benefit of the accuracy and automation and still having a small end economic bunker and loading conveyor.

According to a sixth aspect, the control system is programmed to control the discharge of the supplemental portion depending on a measured weight of the loaded main portion and/or a signal confirming the discharge of a predetermined weight of the main portion.

According to an seventh aspect, the apparatus according to at least one of the previous aspects may comprise at least 10 bunkers, wherein the control system is programmed to assign at least two of the bunkers to a main component of the feed mix, such as a roughage type.

According to a eighth aspect, the loading conveyor and/or each of the bunkers may comprise a weighing system.

According to a ninth aspect of the invention, the apparatus for preparing feed mixes for livestock, comprises:
stationary mixers for preparing a predetermined feed mix from a plurality of feed types including at least one main component of a roughage type and byproducts;
loading areas for a loading vehicle, for loading the at least one main component into the mixers;
the apparatus according to at least one of the previous claims, for transporting on the loading conveyor the discharged byproducts and/or discharged supplemental portions of the at least one main component towards the mixers; and
a cross conveyor alternatively connecting the loading conveyor with one of the mixers.

Thus the capacity and performance of an automated apparatus can be optimized. For instance, the apparatus may comprise two stationarily installed mixers each having a capacity of at least 10,000 kg, in preferably at least 20,000 kg. The mixers may be equipped with an electric drive, weighing bars and a programmable logic controller (PLC). The mixers may be used in an alternating manner.

The cross conveyor directs the flow of material either from a mineral collection bin or the loading conveyor towards the chosen mixer. The cross conveyor is also mounted on weighbars to know that it is empty or feed is still on its way to the chosen mixer.

According to a tenth aspect the apparatus further comprises silos for mineral feed types and a mineral collection bin connected to the silos and discharging over the cross conveyor.

The mineral collection unit is mounted on weighbars. There may be an afterfall function (as explained above) for the mineral collection unit in the control system and/or a frequency drive (as explained above) to be able to selectively drive the auger motors for the mineral/concentrate collection at lower speeds, in particular shortly before reaching the target weight of a particular mineral/concentrate.

According to a eleventh aspect of the invention, a method for preloading a plurality of feed types of a feed mix for livestock in a mixing plant comprises the steps of: selectively discharging one of the feed types each from a plurality of bunkers onto a loading conveyor and conveying the feed types on the loading conveyor towards a mixer for preparing the feed mix. The discharging and conveying of the feed types is controlled by a computer program holding a preloading plan of a preloading cycle, the preloading plan defining at least preloading weights of the feed types to be discharged onto the loading conveyor. The computer program sequentially moves dump spots of the loading conveyor to dump areas of the bunkers and individually controls the discharge the feed types onto the dump spots, depending on the preloading plan, and in particular depending on space/weight capacities of the dump spots for the individual feed types, wherein the computer program terminates the preloading cycle when a predetermined total weight of the required feed types is reached, or interrupts the preloading cycle when a maximum weight capacity of the loading conveyor is reached or when the loading sensor at the downstream end of the loading conveyor is triggered by feed on the chain, and transports the preloaded feed types together towards the mixer, in particular following a demand signal from the mixer, calling for the feed types.

The quantities to be loaded are fixed in a ration. Only the supplementary portions need to be calculated. Thus, the preloading may be adapted in a flexible manner.

The general loading sequence is programmed in the main control unit. For instance, a user (farmer) can determine that concentrates are loaded out of the precollection bin first, followed by feed from the bunkers. Or precollected concentrates are conveyed to the mixer in between emptying the preloaded feed quantity on the loading conveyor and resuming the loading from the bunkers. This may be entirely flexible.

According to a twelfth aspect, the the computer program may determine a remaining loading capacity of at least one dump spot that has not been fully loaded with a first feed type and controls the discharge of at least a second feed type such that the dump spot is fully loaded with the first feed type and the at least second feed type.

According to a thirteenth aspect of the invention, a method for loading feed types of a feed mix for livestock comprises: selectively loading one or more of the feed types from one or more bunkers directly or indirectly in a mixer for preparing the feed mix; wherein at least one of the feed types is directly or indirectly loaded in the mixer as a supplemental portion of a main component of the feed mix, in particular of a roughage type, loaded into the mixer with a loading vehicle, wherein the loading is controlled such that the weight of the main portion and the weight of the supplemental portion add up to a programmed total weight of the main component.

The method may comprise selectively discharging one of the feed types each from a plurality of bunkers onto a loading conveyor and conveying the feed types on the loading conveyor towards a mixer for preparing the feed mix. The discharging and conveying of the feed types is controlled by a computer program holding a preloading plan of a preloading cycle, the preloading plan defining at least preloading weights of the feed types to be discharged onto the loading conveyor. At least one of the feed types to be discharged on the loading conveyor is a supplemental portion of a main component of the feed mix, such as a roughage type. The computer program sequentially moves dump spots of the loading conveyor to dump areas of the bunkers and individually controls the discharge the feed types onto the dump spots, depending on the preloading plan, wherein the computer program controls the discharge of the supplemental portion of the main component in accordance with a main portion of the main component loaded into the mixer by means of a loading vehicle, such that the weight of the main portion and the weight of the supplemental portion add up to the programmed total weight of the main component.

For each feed mix, the control system computes a particular preloading plan taking into account the desired sequence of the feed types and the positions of the associated bunkers, as well as the total target weights of the feed types. Based thereon, the control system computes a sequence defining which dump spots are to be completely loaded with a single feed type and which dump spots are to be sequentially loaded with two different feed types. Thus the available space on the loading conveyor can be efficiently used for precollecting as many feed types as possible between the bunkers and the cross conveyor.

It might be beneficial to fill the bunkers closest to the mixers with the main components, e. g. two types of grass, corn and GPS.

According to a fourteenth aspect, the loaded main portion may be weighed in the mixer and/or the loading of a predetermined weight of the main portion may be manually confirmed at the loading vehicle, and the computer program may calculate the weight of the supplemental portion depending on the measured and/or confirmed weight of the loaded main portion.

According to a fifteenth aspect, a first subgroup of the bunkers may contain different byproducts of the feed mix and a second subgroup of the bunkers may contain different main components of the feed mix. The minerals can be provided in silos.

According to a sixteenth aspect of the invention, a method for preparing a predetermined feed mix from a plurality of feed types including at least one main component consisting in particular of at least one of a roughage type and silage, and including multiple byproducts, wherein the byproducts and/or a supplemental portion of at least one of the main components are preloaded and conveyed according to at least one of the previous aspects, and a main portion of the at least one main component is loaded into a selected one of at least two mixers by means of a loading vehicle. Moreover, the preloaded byproducts and/or the at least one preloaded supplemental portion are fed into the selected mixer by means of a cross conveyor selectively connecting the loading conveyor with the selected mixer.

The loading of at least one of the byproducts, the supplementary portions of the main components and the minerals can be automated by means of the control system comprising at least one PLC.

A loading vehicle is preferably used to feed the main components into the mixers and the associated subgroup of bunkers and to feed the byproducts into the associated subgroup of bunkers. The loading vehicle can be a payloader, a telehandler, a tractor with frontloader or the like.

The loading conveyor can be a loading chain, a loading belt or the like.

An in-cab controller with a touchscreen or the like may be provided in the loading vehicle and can be wirelessly connected to the PLC via known data transfer techniques.

Any of the aspects and/or features disclosed above can be combined with each other.

### BRIEF DESCRIPTION OF THE DRAWINGS

In the following an embodiment of the invention is described in detail with reference to the following figures showing:

FIG. 1 an overview of an apparatus for preparing feed mixes;

FIG. 2 a more detailed view of the apparatus;

FIG. 3 a loading conveyor with different feed types discharged from the bunkers;

FIG. 4 the upstream end of the loading conveyor;

FIG. 5 the downstream end of the loading conveyor;

FIG. 6 a control system of the mixing plant;

FIG. 7 a schematic diagram of a method for preparing feed mixes; and

FIG. 8 a schematic diagram of a method for preloading feed types onto the loading conveyor; and

FIG. 9 an alternative variant of the apparatus for direct loading into the mixer.

### DETAILED DESCRIPTION OF THE PREFERRED EMBODIMENTS

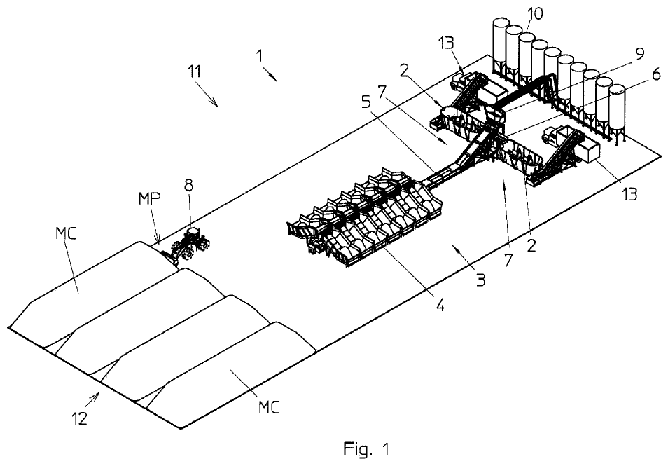

As can be seen from FIG. 1, the apparatus 1 for preparing feed mixes for livestock comprises two mixers 2, an apparatus 3 for preloading a plurality of feed types/feed components of a feed mix by means of a plurality of bunkers 4 and a loading conveyor 5, and a cross conveyer 6 selectively connecting the loading conveyor 5 with one of the mixers 2. The mixers 2 can be of a vertical type, horizontal type or reel type or any other type.

The apparatus 1 further comprises loading areas 7 for at least one loading vehicle 8, a mineral collection bin 9 arranged over the cross conveyer 6 and receiving minerals and/or concentrates for the feed mixes from a plurality of silos 10.

The apparatus 1 is part of a so-called feed kitchen 11 comprising roughage heaps 12 that may be located in commodity barns (not shown) for providing a plurality of main components MC, which may consist of corn silage, grass silage of a first quality, grass silage of a second quality, and GPS silage.

The loading vehicle 8 picks up a main portion MP of at least one of the main components MC and loads the same into one of the mixers 2 activated for preparing a particular feed mix. The prepared feed mixes are eventually discharged into feed out trucks 13.

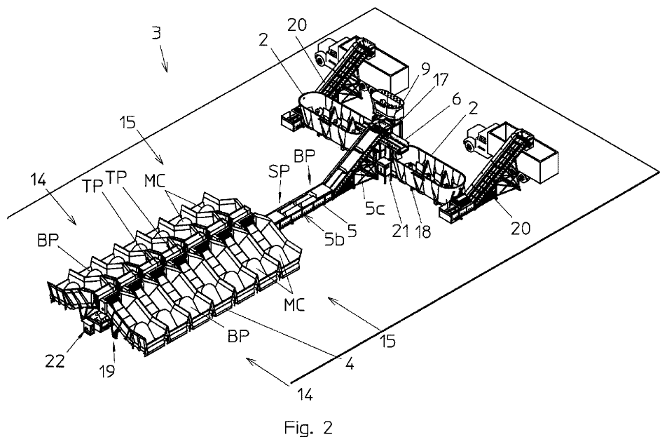

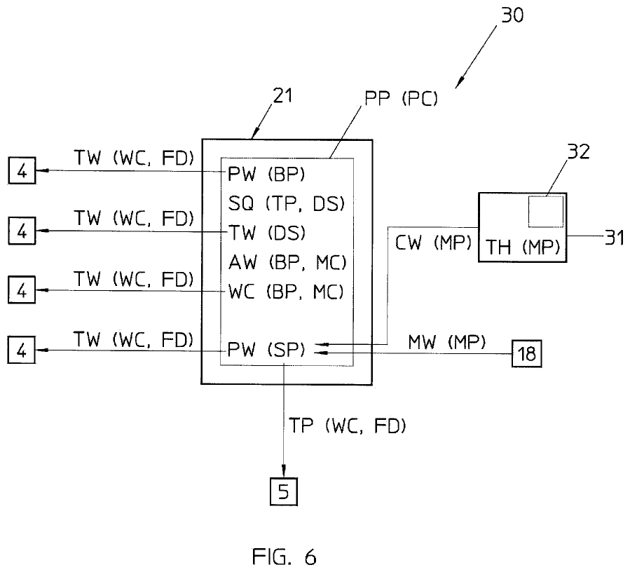

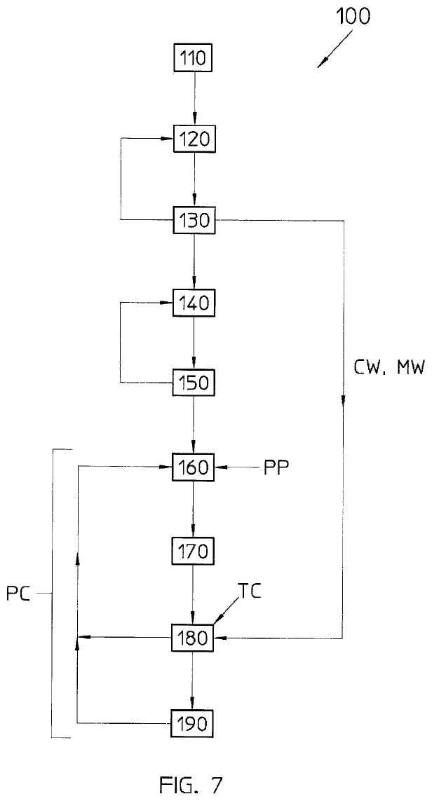

As can be seen in FIG. 2, a first sub-group 14 of the bunkers 4 is used to provide different byproducts BP, and a second sub-group 15 of the bunkers 4 is used to provide supplemental portions SP of the main components MC. As explained in more detail with respect to FIGS. 6 and 7, the main portions MP of the main components MC are loaded into the mixers 2 by means of the loading vehicle 8, whereas the supplemental portions SP of the same main components MC are discharged from the bunkers 4 onto the loading conveyor 5 and added to the main portions MP already loaded into in the mixers 2, by means of the cross conveyer 6.

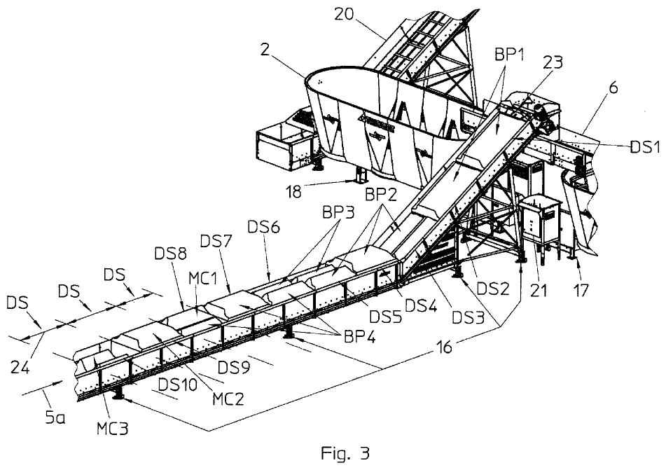

As can be seen from FIG. 3 in more detail, the byproducts BP required in the feed mix and the supplemental portions SP of the main components MC required in the feed mix are preloaded/pre-collected on the loading conveyor 5 and conveyed together to the mixer 2 used for the particular feed mix.

The loading conveyor 5, the cross conveyer 6, and each of the mixers 2 are mounted on weighing systems 16, 17, 18, to monitor the weight of the byproducts BP and the supplemental portions SP during pre-discharging, conveying, and collecting the same on the loading conveyor 5, the cross conveyer 6 and in the mixers 2, respectively. The bunkers 4 may be individually mounted on weighing systems 19 (FIG. 2) in order to control the individual discharges of the byproducts BP and/or the supplemental portions SP.

The weighing systems 16 to 19 can be of a conventional type, namely incorporated in the legs of the loading conveyor 5, the cross conveyer 6, the mixers 2 and/or the bunkers 4, respectively. Thus, the structure and function of the weighing systems 16 to 19 is not described in detail.

As can be seen from FIGS. 1 to 3, each of the mixers 2 is provided with a feed out conveyer 20 in order to discharge the prepared feed mixes into the feed out trucks 13.

FIGS. 2 and 3 further show a main control unit 21 of the apparatus 3 and/or the mixing plant 1, a drive unit 22, preferably of the hydraulic type, for the bunkers 4 (of both sub-groups 14, 15), a loading sensor 23, preferably of the ultrasonic type, monitoring the loading condition at the downstream end of the loading conveyor 5.

The drive unit 22 comprises an electric motor, a pump and valves (not shown). The drive unit 22 may comprise a frequency drive (electrical power: for instance 7.5 kW) to control (reduce) the speed of the motor and pump. Thus, the discharge speed of the respective bunker 4 can be reduced, for example when reaching 5% from the target weight of a particular discharge. For example, the discharge speed would be reduced to 20% of the initial discharge speed (which would be a reduction from 50 Hz to 10 Hz in Europe, and from 60 Hz to 12 Hz in the USA).

The loading conveyor 5 may be driven by a frequency drive (electrical power: for instance 15 kW) located in a separate panel (not shown). However, the frequency drive of the loading conveyor 5 could be incorporated in the drive unit 22 as well. The frequency drive of the loading conveyor 5 is doing the checking of the pulses on the tensioner and is stopped by the loading sensor 23 (sonar) at the downstream end of the loading conveyor 5. The frequency drive is capable of intermittently driving dump spots DS defined on the loading conveyor 5 to target positions TP at each of the bunkers 4.

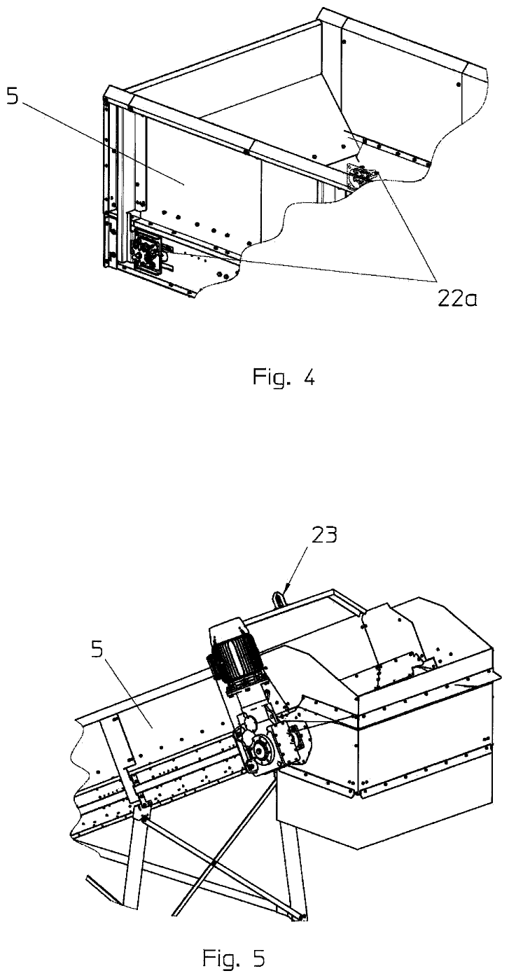

The upstream end of the loading conveyor 5 is depicted in FIG. 4 showing that the drive unit 22 may comprise pulse sensors 22a arranged on the tensioner sprockets of the loading conveyor 5 in order to command the movement of the loading conveyor 5 while preloading. This arrangement can also be used to sense if the loading conveyor 5 is blocked, broken or needs to be tensioned, e. g. in case the delay between starting the frequency drive and the sensing of a movement of the loading conveyor 5 takes too long.

Preferably the bunkers 4 are provided on both sides of the loading conveyor 5. Thus, for the fourteen bunkers 4 shown in FIGS. 1 and 2, seven target positions TP are required.

The downstream end of the loading conveyor 5 with the loading sensor 23 is depicted in FIG. 5.

In order to preload the required byproducts BP contained in the feed mix and/or the supplemental portions SP of the main components MC on to the loading conveyor 5, completely empty dump spots DS or partially empty dump spots DS are sequentially positioned at one of the target positions TP to discharge a planned preload weight PW of the respective component/feed type onto at least one dump spot DS.

In the example according to FIG. 3, first and second dump spots DS1, DS2 (the ones closest to the cross conveyer 6) are filled with a first byproduct BP1, a third dump spot DS3 is partly filled with the first byproduct BP1 and a second byproduct BP2. A fourth dump spot DS4 is completely filled with the second byproduct BP2, a fifth dump spot DS5 is partly filled with the second byproduct BP2 and a third byproduct BP3, a sixth dump spot DS6 is partly filled with the third byproduct BP3 and a fourth byproduct BP4, a seventh dump spot DS7 is completely filled with the fourth byproduct BP4, an eighth dump spot DS8 is partly filled with the fourth byproduct BP4 and a first main component MC1. An ninth dump spot DS9 is completely filled with a second main component MC2. A tenth dump spot DS10 is partly filled with a third main component MC3.

The distances between the target positions TP may basically correspond to the width (in the conveying direction 5a of the loading conveyor 5) of the bunkers 4. In the same manner, the length 24 (in the conveying direction 5a of the loading conveyor 5) of the dump spots DS may basically correspond to the width of the bunkers 4.

However, individual dump spots DS may have different length 24, depending on the width of the bunker 4 used to load a particular dump spot DS and/or depending on the material properties of the discharged byproducts BP and/or main components MC.

In any case, the loading conveyor 5 is virtually segmented into the dump spots DS by sequentially moving receptive sections of the loading conveyor 5 to one of the target positions TP.

It is favourable for the frequency drive to operate the loading conveyor 5 in only one direction. Thus, preloading sequence SQ may start with the required bunkers 4 positioned farthest away from the cross conveyer 6. However, other sequences SQ of loading the chain would be possible as well, such as starting with the bunkers 4 closest to the cross conveyer 6, or starting with all required bunkers 4 positioned on one side of the loading conveyor 5, followed by the required bunkers 4 on the other side, and/or moving the loading conveyor 5 in both directions.

The loading conveyor 5 comprises a basically horizontal section 5b and an upward sloping section 5c (FIG. 2) which can be both used to preload/pre-collect byproducts BP and/or supplemental portions SP of the main components MC prior to discharging the same together into the activated mixer 2. Thus, it is not necessary to empty the loading conveyor 5 and the cross conveyor 6 between the discharge of different feed types (byproducts BP and/or main components MC) onto the loading conveyor 5.

FIG. 6 schematically shows a control system 30 at least including the main control unit 21, the bunkers 4, the loading conveyor 5, the weighing systems 18 of the mixers 2, and an in-cab control unit 31 provided in each loading vehicle 8. The control system may further comprise the weighing systems 16, 17, 19 of the loading conveyor 5, the cross conveyer 6 and/or the bunkers 4, and the loading sensor 23 (not shown in FIG. 6).

In a principally known manner, the main control unit 21 and the in-cab control unit 31 are based on programmable logic controllers (PLC).

The main control unit 21 holds at least one preloading plan PP of a corresponding preloading cycle PC for providing all required byproducts BP and all supplemental portions SP of the required main components MC of a feed mix via the loading conveyor 5. The preloading plan PP comprises at least preloading weights PW of the byproducts BP and the supplemental portions SP to be discharged onto the loading conveyor 5.

Moreover, the preloading plan PP may comprise a sequence SQ of the target positions TP assigned to the required dump spots DS. The target positions TP basically correspond to the positions of the bunkers 4 containing the required byproducts BP and supplemental portions SP.

Since a single dump spot DS may not be capable of receiving the planned preloading weight PW of a particular feed type/component, the preloading weight PW may be divided into target weights TW for each dump spot DS required for the preloading of this particular feed component. If only one dump spot DS is required for a particular feed component, its preloading weight PW corresponds to a single target weight TW.

Preferably, the main control unit 21 further holds information regarding an after-fill function of the bunkers 4 defining how much weight of a particular byproduct BP or main component MC is additionally discharged from the bunkers 4 onto a dump spot DS after the respective bunker 4 has been stopped by the control unit 21. This can be achieved by defining individual after-fill weights AW for each of the byproducts BP and for each of the main components MC, depending on their material properties.

For the discharge of a particular feed component, the main control unit 21 may correct each target weight TW by subtracting therefrom the after-fill weight AW of this feed component. The discharge from the bunkers 4 is then controlled by using these corrected target weights TW and/or the weighing systems 19 provided at the bunkers 4.

The control unit 21 assigns each bunker 4 to a particular byproduct BP or to a particular main component MC. In the same manner, the target positions TP can be assigned to each of these feed types/components.

The in-cab control unit 31 may comprise a confirm button 32 enabling a driver of the loading vehicle 8 to confirm that a pre-determined main portion MP of a particular main component MC has been done. This can be achieved by completely filling the bucket of the loading vehicle 8 with the main component MC, thereby loading a substantially reproducible quantity of known weight into the activated mixer 2. After loading of a required number of buckets, the loading of the main portion MP is confirmed. This creates a confirmed weight CW of the main portion MP, used by the main control unit 21 for calculating the planned preloading weight PW of the associated supplemental portion SP of this particular main component MC.

Moreover, the main control unit 21 and/or the in-cab control unit 31 may hold a threshold TH for each of the main components MC, defining minimum weights of their main portions MP to be loaded by means of the loading vehicle 8 into the activated mixer 2. In this case, the weighing system 18 of the respective mixer 2 weighs the loaded main portion MP of a particular main component MC, thereby yielding a measured weight MW of the main portion MP.

The main control unit 21 and/or the in-cab control unit 31 check whether the measured weight MW has reached the threshold TH. If so, the driver of the loading vehicle 8 is informed that the main portion MP of this particular main component MC is done, and the driver can move to the next job. Moreover, the measured weight MW of the main portion MP is used by the main control unit 21 to calculate the planned preloading weight PW of the corresponding supplemental portion SP of this particular main component MC.

This procedure of calculating preloading weights PW of supplemental portions SP based on confirmed weights CW/measured weights MW of main portions MP loaded into the mixer 2 is repeated for all required main components MC, thereby completing the preloading plan PP.

FIG. 6 further indicates that the main control unit 21 controls the bunkers 4 to discharge the target weights TW of the required feed types on the assigned dump spots DS, based on specific weight capacities WC of the (empty) dump spot DS for each of the different feed types/components, and based on the filling degrees FD of the individual dump spots DS (the available space for each individual discharge from a bunker 4).

The main control unit 21 controls (the drive unit 22 of) the loading conveyor 5 to position the dump spots DS at the target positions TP, also based on the weight capacities WC and the filling degrees FD.

FIG. 7 shows a schematic diagram of the steps performed in an embodiment of a method/procedure 100 of preparing a feed mix.

After the start of the mixing procedure 100, the described steps 110 to 190 can be performed simultaneously and/or in a overlapping manner, depending on the availability of required input parameters, such as confirmed weights CW/measured weights MW of the loaded main portions MP, the remaining weight/space capacity of the loading conveyor 5, and/or the availability of the cross conveyer 6 (being busy or not).

In a step 110, a prefilling plan (not shown) predetermining the main portions MP or the thresholds TH of the required main components MC to be loaded by means of the loading vehicle 8 is read and displayed on the in-cab control unit 31.

In a step 120, the loading vehicle 8 picks up one of the required main components MC at the associated roughage heap 12 and loads this main component MC into the activated mixer 2. Preferably, the loading vehicle 8 loads completely filled buckets into the mixer 2.

In a step 130, the loading of this main component MC into the mixer is terminated by confirming the completed loading of the predetermined main portion MP at the in-cab control unit 31 and transmitting a confirmed weight CW of the main portion MP/main component MC to the main control unit 21. Alternatively, once an associated threshold TH of the main portion MP is reached (and displayed), the loading of the main portion MP is terminated, and a measured weight MW of the main portion MP/main component MC is transmitted to the main control unit 21.

The steps 120 and 130 are repeated for the other main components MC required in the feed mix until the preloading of the main components MC is done.

In a step 140, the main portions MP of the main components MC already loaded into the mixer 2 are mixed with each other. Simultaneously, other components can be added by performing steps 150 to 190, as explained below.

In the step 150, minerals and/or concentrates precollected in the mineral collecting bin 9 are conveyed by means of the cross conveyer 6 into the activated mixer 2 already containing at least one of the prefilled main components MC. However, the precollection bin 9 usually starts to work and collect what is programmed without requiring the presence of a main component MC in the mixer 2. Thus, the step 150 can start prior to/during the steps 120 to 140.

In a step 160, a preloading plan PP for a preloading cycle PC is read by the main control unit 21 in order to retrieve all available preloading weights PW, normally starting with the predetermined preloading weights PW of the required byproducts BP, and followed by the calculated preloading weights PW of the supplemental portions SP of the required main components MC.

In a step 170, in accordance with the preloading plan PP, receptive dump spots DS are sequentially moved to their target positions TP at the bunkers 4 holding the required byproducts BP and the required main components MC. In accordance with the preloading plan PP, a preloading weight PW of each required byproduct BP and supplemental portion SP is discharged from the corresponding bunker 4. The preloading weight PW may consist of several target weights TW sequentially discharged onto different dump spots DS.

In a step 180, the main control unit 21 checks whether the preloading plan PP can be supplemented/completed with a preloading weight PW of at least one supplemental portion SP. The supplemental portions SP of the required main component MC can only be discharged from the corresponding bunker 4 if the preloading weight PW of this particular supplemental portion SP has been added to the preloading plan PP. To this end, the main control unit 21 calculates the preloading weight PW based on the confirmed weight CW or measured weight MW of the corresponding main portion MP.

The steps 160 to 180 are repeated until all required byproducts BP and supplemental portions SP of the required main components MC have been discharged onto the loading conveyor 5. In this case, the complete preloading cycle PC has been done.

Alternatively, the preloading cycle PC can be interrupted when a maximum total capacity TC of the loading conveyor 5 has been reached. In this case, a step 190 is performed, and the preloading cycle is resumed with steps 160 to 180.

In the step 190, the byproducts BP and the supplemental portions SP/main components MC preloaded onto the loading conveyor 5 are conveyed together to the cross-conveyer 6 discharging all preloaded components into the activated mixer 2.

The cross conveyer 6 can be used to alternately convey preloaded feed types/components from the loading conveyor 5 or minerals/concentrates from the mineral collection bin 9 to the activated mixer 2.

Thus, it is possible to perform at least two of the processes of loading and mixing the main portions MP of the main components MC (steps 110 to 140), precollecting and providing minerals/concentrates (step 150), and the preloading cycle PC of preloading byproducts BP and supplemental portions SP of the main components MC onto the loading conveyor 5 (steps 160 to 190), in a simultaneous and/or overlapping manner.

The mineral/concentrate pre-collection bin 9 can start already at the same time as the manual loading into the mixer 2, the preloading on the loading 5 chain as well. However, in case one works with at least one main portion MP and at least one supplementary portion SP, the control system 30 has to wait until the manually loaded amounts are known, before the preloading of these main components MC can be done.

Appropriate sequences are determined by the main control unit 21 (PLC). It would also be possible to end the whole preloading cycle PC for the bunkers 4 and then start the loading from the precollection bin 9 into the mixer 2, or any other sequences, whatever the farmer likes to do.

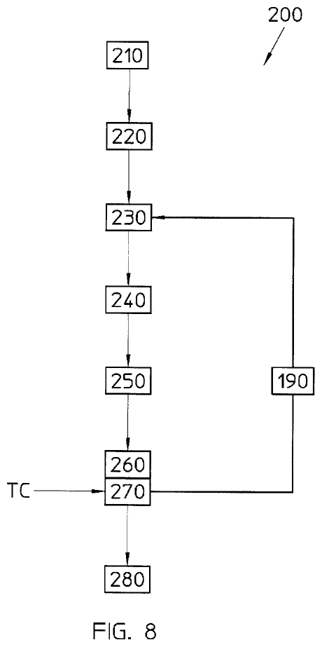

FIG. 8 schematically shows an embodiment of a method/procedure 200 for sequentially discharging different byproducts BP and supplemental portions SP of the main components MC on dump spots DS positioned at the bunkers 4. The method/procedure 200 is part of the preloading cycle PC.

In a first step 210, an appropriate sequence SQ of discharging the different required byproducts BP and supplemental portions SP of the main components MC is determined, depending on the content and position of each bunker 4 holding either one of the byproducts BP or one of main components MC.

In a step 220, a specific (preloading) weight capacity WC of the dump spots DS is determined/read for each required feed type/component in accordance with the preloading plan PP. This means that it is known how much weight of a particular feed type/component normally fits onto one empty dump spot DS.

In a step 230, the preloading weight PW of the first/next feed component of the feed mix, or all available preloading weights PW is/are read in the preloading plan PP.

In a step 240, the filling degree FD of the required dump spot/spots DS is determined for the first/next feed component of the feed mix, or for all available preloading weights PW. If a dump spot DS is empty, the filling degree FD is zero. The filling degree FD of a full dump spot would be 1 or 100% (in this case, however, it would not be available).

The specific weight capacity WC of a dump spot DS for a feed type to be discharged, and the filling degree FD of the dump spot DS determine the available/remaining loading capacity of this dump spot DS for the corresponding discharge from a bunker 4.

In a step 250, target positons TP and target weights TW are determined for the dump spot/spots DS required for the first/next feed component of the feed mix, or for all available preloading weights PW. This depends on the filling degrees FD of the individual dump spots, in particular when moving to next component and starting its discharge onto a partially filled dump spot DS. The preloading weight PW of a particular feed component can be distributed to several dump spots DS and associated target weights TW.

In a step 260, the calculated (and optionally afterfill-corrected and/or pulse-controlled) target weights TW are discharged onto the assigned dump spot DS sequentially positioned at the target positions TP at one of the bunkers 4.

At the same time, the main control unit 21 checks in a step 270 whether all components contained in the preloading plan PP have been done and/or whether a maximum total capacity TC of the loading conveyor 5 has been reached.

The maximum total capacity TC can be a weight capacity and/or a space capacity. In comparison therewith, the actual total weight on the loading conveyor 5 can be monitored by means of the weighing system 16, and/or the occupied space on the loading conveyor 5 can be monitored by means of the loading sensor 23 arranged at the downstream end of the loading conveyor 5. If the loading sensor 23 detects the arrival of a filled dump spot DS, the maximum total capacity TC is reached.

In case the maximum total capacity TC has been reached, the ongoing preloading cycle is interrupted in a step 270.

After complete emptying of the loading conveyor 5 via the cross conveyer 6 (according to step 190), the preloading cycle PC is resumed in accordance with the preloading plan PP, preferably by continuing with step 230.

If the main control unit 21 determines in step 270 that all required components have been preloaded, the preloading cycle PC is terminated in step 280.

The steps 210 to 260 can be performed at any time for a single feed type/component or for several feed types/components of the feed mix, as soon as the required preloading weight PW of the particular component, in particular of a supplemental portion SW, is available.

In the following, a practical example of a performed mixing procedure is described.

In the beginning, the main control unit 21 sent a prefill plan with all required main components MC to be loaded “manually” by means of the loading vehicle 8 to the screen of the in-cab control unit 31 to instruct the driver to load 6000 kg of grass silage of type 1 (first main component MC1) and 10000 kg of corn silage (second main component MC2). The driver tries to load as quickly as possible by completely filling the bucket of the loading vehicle 8, holding 2700 kg of grass silage of type 1 and 3200 kg of corn silage.

The driver put in two full buckets of grass silage type 1, then pushed the button to confirm the end of the job. This created a confirmed weight CW of 5400 kg. The remaining quantity of 600 kg was calculated as the preloading weight PW of the supplemental portion SP of grass silage type 1 and was entered into the preloading plan PP of the preloading cycle PC.

Alternatively, a threshold TH of a minimum prefill quantity of 4500 kg could be programmed for grass silage type 1. The preloading weight PW of the supplemental portion SP of grass silage type 1 might then amount to anything below 1500 kg, depending on the required total amount of grass silage type 1 and the measured weight MW of grass silage type 1 loaded into the activated mixer 2.

Afterwards, the driver put in three buckets of 3200 kg each for the corn silage, leaving 400 kg as planned preloading weight PW of the supplemental portion SP of corn silage to be discharged from the corresponding bunker 4.

The pre-collection of the other feed types/components of the feed mix started in the collection bin 9 for the minerals/concentrates, in this example two minerals of 500 kg each and two concentrates of 250 kg each. Thus, four silos 10 were activated one by one respecting component afterfall and pulse speed of the respective drive until the desired weights were reached, while being controlled by the main control unit 21.

Moreover, the maximum total capacity TC of the loading conveyor 5 was 3200 kg.

The preloading plan PP contained the following preloading weights PW of the following byproducts BP: 1000 kg of brewers grain; 700 kg Alfalfa hay; 400 kg sugar beet pulpe; and 400 kg cotton seed.

The preloading plan PP was completed by adding the calculated preloading weight PW of the supplemental portions SP as follows: 600 kg of grass silage type 1; and 400 kg silage corn.

One dumping spot DS the loading conveyor 5 could hold: 400 kg of brewers grain, requiring 2.5 dumping spots DS; 350 kg Alfalfa hay, requiring 2 dumping spots; 400 kg sugar beet pulpe, requiring 1 dumping spot; 200 kg cotton seed, requiring 2 dumping spots; 600 kg grass silage type 1, requiring 1.5 dumping spots; and 600 kg silage corn, requiring 0.66 dumping spots.

This filled loading conveyor 5 looked as schematically depicted in FIG. 2.

However, since the maximum total capacity TC was 3200 kg, the ongoing preloading cycle was interrupted after the discharge of 100 kg of silage corn.

After emptying the loading conveyor, the preloading cycle was resumed by discharging the remaining 500 kg of silage corn onto the loading conveyor 5.

The preloading sequence SQ started with the required bunker 4 positioned farthest away from the cross conveyer 6, and the activated bunkers 4 dropped the components on the assigned dumping spots DS one by one.

If the particular dumping spot DS was big enough for the planned preloading weight PW, it was calculated how many percent the dumping spot DS would be filled. If the dumping spot DS was too small for the preloading weight PW, the discharge from the bunker stopped at the calculated preloading capacity WC of the dumping spot DS. Then, the loading conveyor 5 was moved a defined number of pulses (of the drive unit 22) bringing the next available dumping spot DS under the activated bunker 4, and then the preloading cycle was continued accordingly until the desired preloading weight PW (making use of an afterfall function and/or a pulse function of the bunker 4) was discharged on the loading conveyor 5. Then the main control unit 21 determined for how many percent the last dumping spot DS was filled, so the next feed type could be dumped on top (until complete filling of the dump spot).

As soon as the “manual” preloading of the activated mixer 2 had been done by the driver of the loading vehicle, the supplemental portions SP to be discharged from the bunkers 4 were calculated, thereby completing the preloading plan PP, and were joined to the ongoing preloading cycle.

In case the maximum total capacity TC of the loading conveyor 5 was surpassed according to the preloading plan PP, the supplemental portions SP of the main components were added as the last components by the main control unit 21.

This practical example proved to be particularly fast and efficient.

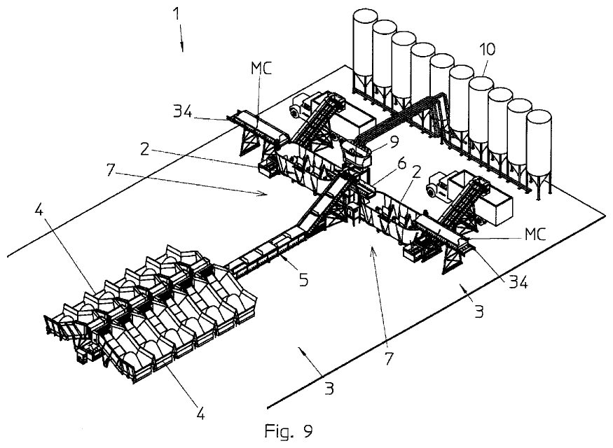

FIG. 9 shows a variant of the mixing plant 1/the apparatus 3 shown in FIG. 1, this variant additionally comprising bunkers 34 each directly loading one of the main components MC into the mixers 2. Otherwise, the reference signs used in FIG. 8 designate the same components as described in reference to FIG. 1.

The bunkers 34 are arranged at/over the mixers 2. The bunkers 34 are activated after the corresponding preloading with the loading vehicle 8 has ended.

Thus, the bunkers 34 can provide a supplemental portion SP of a main component MC in order to supplement a main portion MP (loaded with the loading vehicle 8) of the main component MC such that the weight of the main portion MP and the weight of the supplemental portion SP add up to the programmed total weight of the main component MC.

In principle, this variant can be controlled in the same manner as described with regard to the indirect loading from the bunkers 4 via the loading conveyor 5. However, for this main component MC, the (directly loaded) supplementary portion SP is not added to the preloading plan PP/the precollection routine for the bunkers 4 and the loading conveyor 5.

Direct loading with one or more bunkers 34 is advantageous if the supplementary portion SP is a too big quantity (too heavy or voluminous) to add to the preloading on the loading conveyor 5 and/or if there is a lack of space for the loading conveyor 5 (the loading conveyor 5 otherwise becoming too long).

Indirect loading with one or more bunkers 4 via the the loading chain 5 is advantageous because time can be safe with a precollecting routine based on the preloading plan PP and/or because only one bunker 4 is needed to supply to both mixers 2. This is particularly useful if all possible rations should be done with each of the mixers 2.

Direct loading from at least one bunker 34 is also an option in case there is only a single mixer 2 without a loading conveyor 5. This would mean that direct loading is controlled without the preloading plan PP. Instead, the at least one bunkers 34 directly dumps the feed components in the mixer 2.

What is claimed is:

1. An apparatus for loading feed types of a feed mix for livestock, the apparatus comprising:
one or more bunkers configured for selectively loading one or more of the feed types directly or indirectly in a mixer for preparing the feed mix; and
a control system programmed to load at least one of the feed types directly or indirectly in the mixer as a supplemental portion of a main component of the feed mix, in particular of a roughage type, loaded into the mixer with a loading vehicle, such that a weight of the main portion and a weight of the supplemental portion add up to a programmed weight of the main component.

2. The apparatus according to claim 1, the apparatus further comprising:
a loading conveyor for conveying the feed type/types towards the mixer, wherein the control system is programmed:
to hold a preloading plan of a preloading cycle, defining at least a preloading weight of the feed type/types to be discharged onto the loading conveyor, wherein at least one of the feed types to be discharged on the loading conveyor is the supplemental portion; and
to sequentially position dump spots of the loading conveyor at the bunker/bunkers and to individually discharge the feed type/types from the bunker/bunkers onto the dump spots, depending on the preloading plan; and
to control the discharge of the supplemental portion in accordance with the main portion loaded into the mixer such that the weight of the main portion and the weight of the supplemental portion add up to the programmed weight of the main component.

3. The apparatus according to claim 1, wherein:
the control system is programmed to control the discharge of the supplemental portion depending on a measured weight of the loaded main portion and/or a signal confirming the loading of a predetermined weight of the main portion.

4. The apparatus according to claim 1, comprising:
at least two bunkers, wherein the control system is programmed to assign at least one of the bunkers to a main component of the feed mix, in particular of a roughage type.

5. The apparatus according to claim 1, wherein:
the loading conveyor and/or each of the bunkers comprises a weighing system.

6. An apparatus for preloading a plurality of feed types of a feed mix for livestock, the apparatus comprising:
a loading conveyor for conveying the feed types towards a mixer for preparing the feed mix;
one or more bunkers each configured for selectively discharging one of the feed types on the loading conveyor; and
a control system programmed:
to hold a preloading plan of a preloading cycle, defining at least a preloading weight of the feed type/types to be discharged onto the loading conveyor;
to sequentially move dump spots of the loading conveyor under the bunker/bunkers and to individually discharge the feed type/types onto the dump spots, depending on the preloading plan; and
to terminate the preloading cycle when a predetermined total weight of the required feed type/types is reached, or to interrupt the preloading cycle when a maximum preloading capacity of the loading conveyor is reached or feed reaches a downstream end of the loading conveyor, and convey the preloaded feed type/types together towards the mixer.

7. The apparatus according to claim 6 comprising:
at least two bunkers configured for selectively discharging one of the feed types on the loading conveyor.

8. The apparatus according to claim 6, wherein:
the control system is further programmed to automatically resume the preloading cycle after the loading conveyor has been emptied.

9. The apparatus according to claim 6, wherein:
a length of the dump spots substantially corresponds to a width of the bunkers, when seen in a conveying direction of the loading conveyor, and the control system is programmed to intermittently drive the loading conveyor over distances substantially corresponding to the length of the dump spots.

10. The apparatus according to claim 6, wherein:
the control system is programmed to determine remaining loading capacities of the dump spots that have not been fully loaded with a particular feed type.

11. Apparatus for preparing feed mixes for livestock, comprising:
stationary mixers for preparing a predetermined feed mix from a plurality of feed types including at least one main component of a roughage type and byproducts;
loading areas for a loading vehicle, for loading the at least one main component into the mixers; and
the apparatus according to claim 1, for transporting, in particular indirectly on the loading conveyor, the discharged byproducts and/or discharged supplemental portions of the at least one main component towards the mixers.

12. Apparatus according to claim 11, further comprising:
a loading conveyor for transporting the discharged byproducts and/or discharged supplemental portions of the at least one main component towards the mixers; and
a cross conveyor alternatively connecting the loading conveyor with one of the mixers.

13. The apparatus according to claim 12, further comprising:
silos for mineral/concentrate feed types and a mineral collection bin connected to the silos and discharging over the cross conveyor.

14. A method for loading feed types of a feed mix for livestock, the method comprising the steps of:
selectively loading one or more of the feed types from one or more bunkers directly or indirectly in a mixer for preparing the feed mix; wherein at least one of the feed types is directly or indirectly loaded in the mixer as a supplemental portion of a main component of the feed mix, in particular of a roughage type, loaded into the mixer with a loading vehicle, wherein the loading is controlled such that a weight of the main portion and a weight of the supplemental portion add up to a programmed weight of the main component.

15. The method according to claim 14, further comprising the steps of:
selectively discharging one of the feed types each from the one or more bunkers onto a loading conveyor and conveying the feed type/types on the loading conveyor towards the mixer, wherein the discharging and conveying of the feed type/types is controlled by a computer program holding a preloading plan of a preloading cycle, following at least a weight of the feed type/types required in the feed mix, wherein at least one of the feed types/the feed type to be discharged on the loading conveyor is the supplemental portion, wherein the computer program sequentially moves dump spots of the loading conveyor under the bunker/bunkers and individually controls the discharge of the feed type/types from the bunker/bunkers onto the dump spots, depending on the preloading plan, and wherein the computer program controls the discharge of the supplemental portion in accordance with the main portion loaded into the mixer with the loading vehicle, such that the weight of the main portion and the weight of the supplemental portion add up to the programmed weight of the main component.

16. The method according to claim 14, wherein:
the loaded main portion is weighed in the mixer and/or loading of a predetermined weight of the main portion is manually confirmed at the loading vehicle, and wherein the computer program calculates the weight of the supplemental portion depending on the measured and/or confirmed weight of the loaded main portion.

17. The method according to claim 14, wherein:
a first subgroup of the at least one bunker contains different byproducts of the feed mix and a second subgroup of the at least one bunker contains different main roughage components of the feed mix.

18. A method for preloading one or more feed types of a feed mix for livestock, the method comprising the steps of:
selectively discharging one of the feed types each from one or more bunkers onto a loading conveyor and conveying the one or more feed types on the loading conveyor towards a mixer for preparing the feed mix, wherein the discharging and conveying of the feed type/types is controlled by a computer program holding a preloading plan of a preloading cycle, following at least a weight of the feed type/types required in the feed mix, wherein the computer program sequentially moves dump spots of the loading conveyor under the bunker/bunkers and individually controls the discharge of the feed type/types from the bunker/bunkers onto the dump spots, depending on the preloading plan, and wherein the computer program terminates the preloading cycle when a predetermined total weight of the required feed type/types is reached, or interrupts the preloading cycle when a maximum preloading capacity of the loading conveyor is reached or feed reaches a downstream end of the loading conveyor, and starts the transport of the preloaded feed type/types together towards the mixer, in particular following a demand signal from the mixer, calling for the feed type/types.

19. The method according to claim 18, wherein:
at least two feed types of the feed mix are selectively discharged from at least two bunkers onto the loading conveyor.

20. The method according to claim 18, wherein:
the computer program determines a remaining weight capacity of at least one dump spot that has not been fully loaded with a first feed type and controls the discharge of at least a second feed type such that the dump spot is fully loaded with the first and at least second feed types.

21. A method for preparing a predetermined feed mix from a plurality of feed types including at least one main component of a roughage type and byproducts, wherein the byproducts and/or a supplemental portion of at least one of the main components are preloaded and conveyed according to the method of claim 14, wherein:
a main portion of the at least one main component is loaded into a selected mixer by means of a loading vehicle, and wherein the preloaded byproducts and/or supplemental portion are fed into the selected mixer by means of a cross conveyor selectively connecting the loading conveyor with the selected mixer.
